(19) United States
(12) Patent Application Publication
(10) Pub. No.: US 2009/0126891 A1
(43) Pub. Date: May 21, 2009

(54) Method for Coating Cellulose Particles, Coated Cellulose Particles, and Use Thereof In Paper and Board production

(75) Inventors: Kimmo Koivunen, Espoo (FI); Petri Silenius, Lohja as. (FI); Janne Laine, Espoo (FI); Tapani Vuorinen, Espoo (FI)

Correspondence Address: BIRCH STEWART KOLASCH & BIRCH, PO BOX 747, FALLS CHURCH, VA, 22040-0747, US

(73) Assignee: M-real Oyj, Espoo (FI)

(21) Appl. No.: 11/922,883

(22) PCT Filed: Jun. 27, 2006
(86) PCT No.: PCT/FI2006/050284

§ 371 Date: Mar. 5, 2008

(30) Foreign Application Priority Data
Jul. 1, 2005 (FI) 20055380

(51) Int. Cl. D21H 17/25; B05D 7/00; B32B 5/02; B05D 1/12; C09C 1/02; C09C 1/04

(52) U.S. Cl. 162/176; 427/212; 428/404; 427/180; 106/425; 106/461

(57) ABSTRACT

The invention relates to a method for coating cellulose particles with a light scattering material, to coated cellulose particles, to the use thereof as a filler and as a coating pigment in paper and board, and further, to methods for producing and for coating paper and board.

### FIELD OF THE INVENTION

The present invention relates to a method for coating cellulose particles, and to coated cellulose particles useful e.g. in the production of paper and board. The invention is also directed to a method for producing paper and board, and further, to a method for coating paper and board.

### PRIOR ART

The purpose of coating is to furnish the surface of paper and board with maximum smoothness and uniformity of quality for improving optical properties and printability. The coating consists of pigments, e.g. kaolin, ground calcium carbonate (GCC) and talc, and further, a binder such as a latex and starch, and moreover, said coating may also contain additives such as dispersing agents, agents for pH adjustment, lubricants and anti-microbial agents. Pigments normally comprise from 80 to 95% of the weight of the coating, the pigment thus playing a major role in optical properties of the coating such as opacity, brightness, and gloss. Brightness is improved by low light absorption and high light scattering coefficient, opacity being also improved by the latter. Gloss is influenced for instance by the particle size of the pigment, and by a post-coating treatment e.g. calendering of said paper and board.

In paper and board production, fillers are added to the pulp. The amount of the filler varies according to the product being produced, the proportion thereof normally ranking from 4 to 10% for LWC papers, and from 15 to 30% for chemical pulp papers, relative to the base paper weight. Fillers include e.g. kaolin, calcium carbonate, and titanium dioxide. Also fillers have an influence on optical properties and printability of papers and boards.

Optical properties of paper and board may be improved by increasing the proportion of the pigment in the coating, and the amount of the filler in the base paper. This, however, results in significant deterioration of strength properties of the paper and coating.

Strength properties of paper may also be improved by pulp refining and addition of fines, which, however, often compromises the opacity.

U.S. Pat. No. 6,080,277 discloses a method for producing cellulose particles comprising cationic groups, said cellulose particles being useful in the paper industry for binding disturbing agents to the paper web. The cellulose present in the particles may be unsubstituted or substituted cellulose, such as cellulose esters or ethers, or alkali sellulose. Cellulose is for instance dissolved using the viscose process, N-methyl morpholine N-oxide, or lithium chloride dimethyl acetamide, whereas cellulose derivatives soluble in water, preferably produced by the viscose process, are dissolved using water. A cationization agent is added to the dissolved cellulose, and cationic cellulose particles are obtained by precipitating in the presence of a precipitating agent such as sulphuric acid.

JP 4041289 discloses a coated sheet having a layer containing cellulose particles in a binder at least on one side of a base material. The cellulose particles are produced by a method wherein viscose is used, sprayed with two particle nozzles or the like and dried by hot air to form particles, which are treated by acid or the like to regenerate cellulose. Among the cellulose particles thus formed with grain sizes from 0.1 to 1000 μm, preferably those particles having sizes from 1 to 20 μm are used. The degree of crystallization is claimed to be low, less than 40%, and accordingly, a coating with a high degree of swelling, excellent ink absorbing property, and high color forming density can be formed.

GB 1 574 068 presents a method for coating a particulate or fibrous material, material coated with said method, as well as a method for producing papers comprising said coated material. In the coating method, particles or fibres are slurried in a dilute aqueous solution of a regeneratable cellulose derivative such as cellulose xanthate optionally in the presence of a dispersing agent, followed by the addition of a precipitating agent such as sulphuric acid containing sodium and zinc sulphate to the slurry, resulting in individual particles surrounded by discrete coating of regenerated cellulose. The material to be coated may be kaolin, gypsum, titanium dioxide, or calcium carbonate. The material coated with said method may be used in filler compositions for the production of paper.

Optical properties and bonding strength, often referred to as Scott Bond value, are some of the most crucial properties of printing papers. For boards and papers in general, and particularly for graphical papers, there is a need to improve the strength properties without any adverse effects on the optical properties.

Burning of waste papers containing inorganic mineral pigments for energy production results is great amounts of ash, the disposal of which causes problems. Within the European Union, aims concerning the proportion of bioenergy in the total energy production to be reached until 2010 are set. For these aims, it is also desirable to use as much renewable organic materials as possible in papers and boards.

Inorganic mineral pigments are abrasive and result in accelerated wear of apparatuses. They also increase the weight of paper and board. There is an ever growing need for increasingly lighter papers for magazines, catalogues and the like, furnished, however, with high quality printing properties.

As may be seen on the basis of the above teachings, there is an obvious need for lighter fillers and coating pigments of novel types for papers and boards allowing for the improvement of the strength properties thereof without any detrimental effects on optical properties, and further allowing for the increase of the proportion of renewable and combustible organic materials therein, and the reduction of wear of the equipment.

### OBJECTS OF THE INVENTION

An object of the invention is to provide a method for coating cellulose particles.

Another object is also to provide novel coated cellulose particles.

Further, an object of the invention is the use of coated cellulose particles as a filler in paper and board, and as a coating pigment in the production thereof.

Still another object of the invention is to provide a method for producing paper and board.

Another object of the invention is to provide a method for coating paper and board.

Characteristic features of the inventive coating method for cellulose particles, coated cellulose particles, use of the coated cellulose particles, as well as methods for coating and production of paper and board, are presented in the claims.

### SUMMARY OF THE INVENTION

In the method for coating cellulose particles of the invention, cellulose particles are contacted with a light scattering material to attach said light scattering material on said cellulose particles. A light scattering material refers here to silica, silicate, precipitated calcium carbonate (PCC), gypsum, calcium oxalate, titanium dioxide, aluminium hydroxide, barium sulphate, zinc oxide, modifications or combinations thereof, or any other light scattering materials.

Coated cellulose particles comprise cellulose particles coated with the light scattering material defined above, said light scattering material and a cellulose particle comprising from 5 to 95%, and from 95 to 5% by weight of the coated particle, respectively.

Cellulose particles coated with the method of the invention may be used as fillers of paper and board for improving the strength properties of the product without any detrimental effects on optical properties. Coated cellulose particles obtained by the method of the invention may further be used as coating pigments of paper and board.

The invention is now illustrated with the following figures, detailed description and examples without wishing to limit the invention thereto.

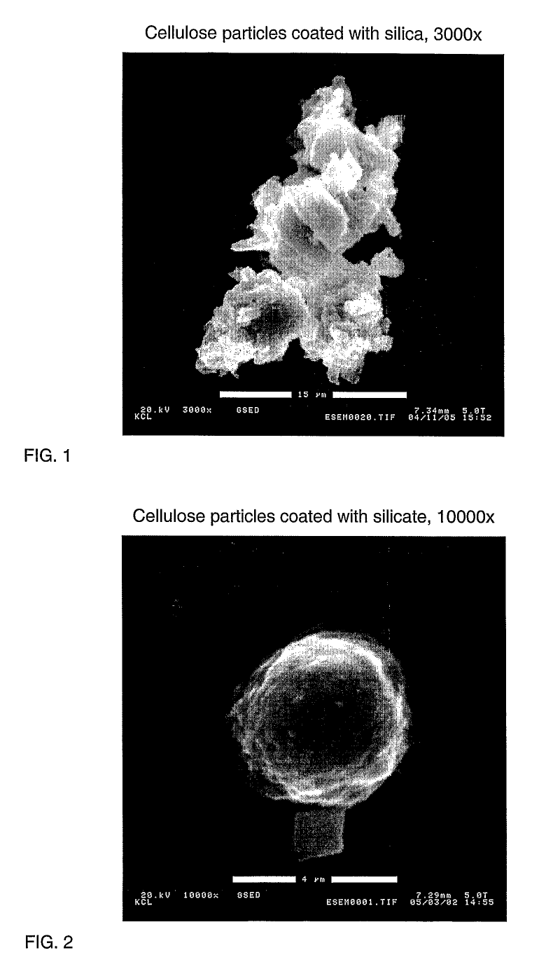

FIG. 1 shows an electron micrograph (magnification ×3000) of cellulose particles of the invention, produced according to example 2 and coated with silica.

FIG. 2 shows an electron micrograph (magnification ×10000) of cellulose particles of the invention, produced according to example 3 and coated with silica.

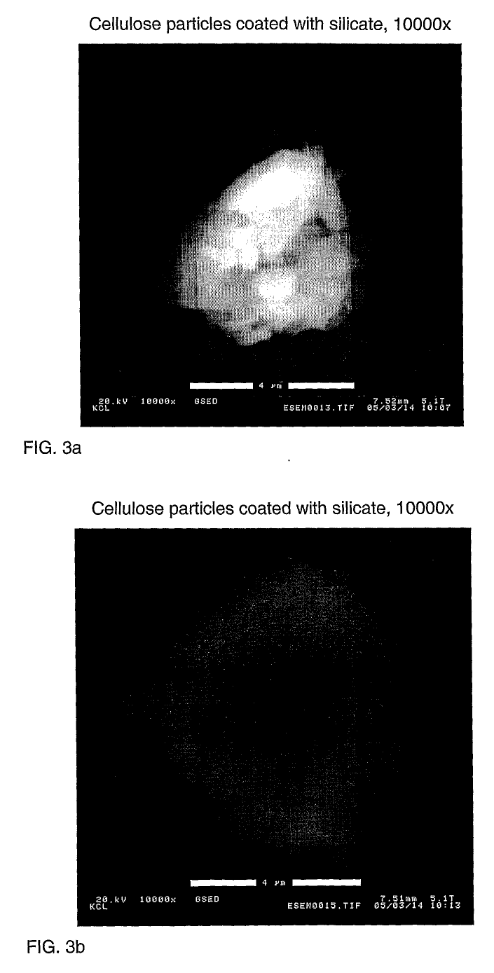

FIGS. 3a and 3b show an electron micrograph (magnification ×10000) of cellulose particles of the invention, produced according to example 4 and coated with silica.

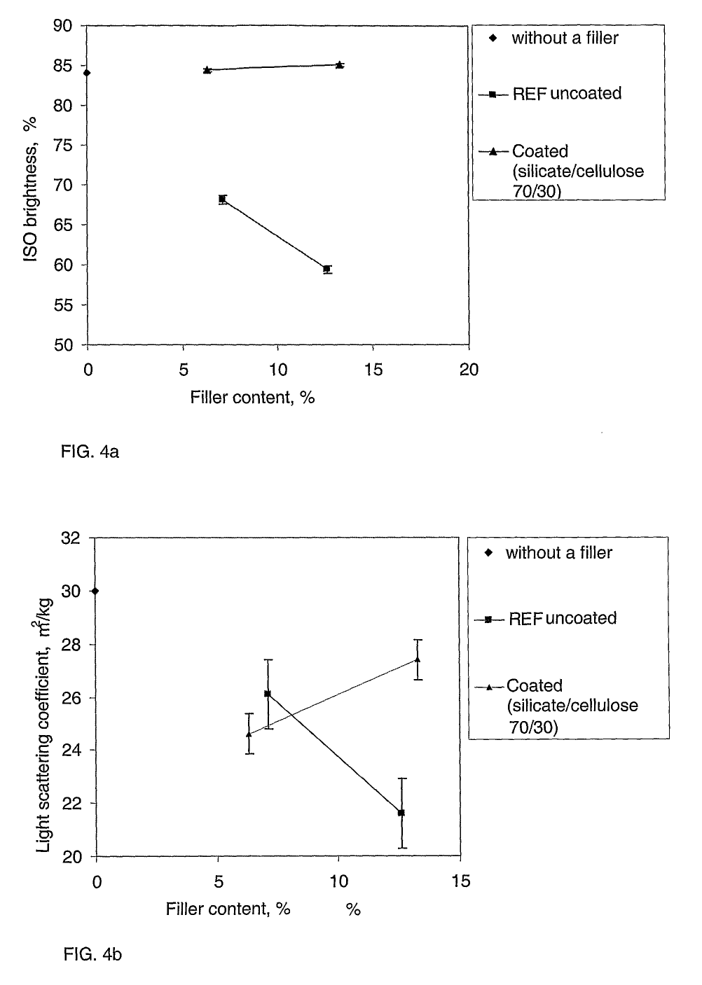

FIGS. 4a and 4b are graphical presentations respectively showing the ISO brightness and the light scattering coefficient of sheets according to Example 6, containing from 6% to 14%, by weight of cellulose particles coated with silicates of the invention, as a function or the filler content. Sheets containing equivalent amounts of non-coated cellulose particles (REF uncoated), and sheets without fillers are used as controls.

### DETAILED DESCRIPTION OF THE INVENTION

It was surprisingly found that problems encountered in the solutions of the prior art may be avoided or at least substantially reduced with the procedure of the invention. The invention is based on the finding that coated cellulose particles useful in the production of paper and board may be obtained by coating cellulose particles, produced from dissolved cellulose by precipitation, with a light scattering material.

In the method of the invention for coating cellulose particles, said cellulose particles are contacted with a light scattering material to allow for the attachment of said material to said cellulose particles. Coating of said cellulose particles may be carried out by precipitation, adsorption, gas phase coating or spin coating method, or the like. It is thus possible to coat said cellulose particles by a modification of said coating methods such as by a modified gas phase coating, e.g atomic layer epitaxy, ALE, process.

In the method of the invention, said cellulose particles to be coated may be produced by any known method, such as by regeneration of cellulose dissolved by the viscose method or a tertiary N-oxide. The cellulose material to be dissolved may for instance be bleached soft wood pulp, cellulosic waste from agriculture or forestry, or the like. Cellulose particles may also be produced by the method described below.

An aqueous suspension is made from the cellulose material to be dissolved, said suspension containing at least 0.1%, by weight, of cellulose; the pH of the suspension is adjusted to a value ranging from 3 to 7, preferable from 4 to 6; an enzyme with endoglucanase activity is added to the suspension to give an endoglucanase activity varying between 20 and 2000*10³ IU/kg of dry cellulose, preferably between 100 and 600*10³ IU/kg of dry cellulose; the suspension containing the enzyme is heated at a temperature varying between 40 and 65° C., preferably between 45 and 60° C., to obtain cellulose having a degree of polymerization reduced not more than to the value of 100; followed by the addition of 15% by weight of an alkali or alkaline earth metal hydroxide to the suspension treated with the enzyme; and thereafter heating at a temperature varying from 15 to 50° C., preferably from 20 to 45° C., to dissolve at least 50% of the cellulose, the cellulose solution thus obtained being then sprayed or mixed to the regenerating solution to precipitate the cellulose particles. It may be preferable to remove air from the dissolved cellulose. Also solids may be removed for instance by filtering. The regenerating solution is preferably an acid, more preferably dilute sulphuric acid. While the particles formed may be left in said regenerating solution for any direct post-treatment such as for coating, they may also be recovered and washed.

In the production of cellulose particles to be used for coating, the cellulose may be modified by conversion thereof to yield a derivative such as a cellulose acetate using any known procedure while the cellulose is in solution or only after regeneration to cellulose particles. Cellulose particles may also be dried or treated with formaldehyde to improve the rigidity of the structure. Porosity of the cellulose particles may be increased for instance by the addition of air to the dissolved cellulose, and following removal of solid material, a substance dissolving in regeneration conditions such as starch and alkali or alkaline earth metal salts such as hydroxides.

Particle size of the cellulose particles to be coated is typically between 0.05 and 10 μm.

The light scattering material to be used in the coating method of the invention may include silica, silicate, precipitated calcium carbonate (PCC), gypsum, calcium oxalate, titanium dioxide, aluminium hydroxide, barium sulphate, zinc oxide, or the like, a modification or a combination thereof.

The silicate to be used in the coating method is selected from the group consisting of metal silicates such as alkaline earth metal silicates, alkali metal silicates, alkaline earth and alkali metal aluminium silicates and modifications thereof, said modifications including mixed salts with salts of alkaline earth metals and hydroxides, and mixed salts and combinations of said compounds. The silicate is preferably a calcium silicate, magnesium silicate, sodium aluminium silicate, sodium magnesium silicate, sodium silicate or aluminium silicate, particularly preferably sodium aluminium silicate.

In the coating method of the invention, also various combinations of the coating materials are contemplated.

### Precipitation of Silica

Silicon dioxide, or silica (SiO₂), may be precipitated for instance according to the following reaction equation (1). A suitable substance to be precipitated, that is, a basic metal silicate, for example an aqueous solution of sodium silicate (water glass), is reacted with a precipitating compound, here a mineral acid, typically with H₂SO₄.

[Na₂O:xSiO₂]+H₂SO₄→xSiO₂+Na₂SO₄+H₂O (1)

Precipitated silica is also obtained by reacting an alkali metal silicate with sulphurous acid or with sulphur dioxide. In addition, an aqueous solution of an alkali metal sulphite or bisulphite is formed.

### Precipitation of Silicates

Synthetic silicates are obtained by reacting a silicon compound acting as the substance to be precipitated with a precipitating compound. The precipitating compound may also be generated in situ during the reaction. Silicates such as sodium aluminium silicate, calcium silicate and aluminium silicate are obtained as the products. Of these, particularly sodium aluminium silicate is the most widely used silicate in papermaking.

Suitable substances to be precipitated include precipitated silicas, metal silicates such as alkaline earth metal silicates and alkali metal silicates, alkaline earth and alkali metal aluminium silicates, and modifications thereof such as mixed salts with salts and hydroxides of alkaline earth metals, and mixed salts and combinations of said compounds.

A silicate, such as sodium silicate, may be precipitated according to the following reaction equation (2). Aluminium sulphate, or alum, is reacted with an aqueous solution of sodium silicate.

[Na₂O:xSiO₂]+Al₂(SO₄)₃→Na₂O.Al₂O₃.4[xSiO₂].4-6H₂O+Na₂SO₄ (2)

Alternatively, an alkali metal silicate may be reacted with an aqueous solution of aluminium sulphite to give precipitated alkali metal aluminium silicate and an aqueous phase containing alkali metal sulphite or bisulphite depending on the pH in final reaction stage.

Precipitated alkali metal aluminium silicate is also obtained by treating an alkali metal silicate solution with an alkali metal aluminate in the presence of sulphur dioxide, sulphurous acid solution, or sulphuric acid solution. In addition, an aqueous phase containing alkali metal sulphite is obtained. In this case, the precipitating aluminium sulphite reagent is formed in situ during the reaction.

Zinc silicate may be precipitated by mixing sodium silicate solution with zinc chloride solution, replacing the zinc chloride solution by a sulphuric acid solution at the end of the reaction.

### Precipitation of Calcium Carbonate

Precipitated calcium carbonate, or PCC, is obtained for instance according to following reaction equations (3)-(5).

CaCO₃+energy→CaO+CO₂ (3)

CaO+H₂O→Ca(OH)₂+energy (4)

Ca(OH)₂+CO₂→CaCO₃+H₂O+energy (5)

In the reaction (3), lime stone is heated, thus dissociating it to give lime, CaO, and carbon dioxide. Next, lime is mixed with water in the reaction (4), thus obtaining slaked lime, Ca(OH)₂. In this step, any impurities may be removed for instance by screening. Calcium carbonate is precipitated in the carbonization step wherein carbon dioxide is passed to an aqueous slurry of the slaked lime in reaction (5). In this step, the particle size, and the particle size distribution of the precipitated calcium carbonate, and further, the shape, and the surface properties of these particles may be influenced by adjusting the reaction conditions.

Calcium carbonate may also be precipitated according to the reaction equation (6). In this equation, slaked lime is reacted with sodium carbonate. The alkaline solution produced in the reaction is neutralized prior to using the CaCO₃ in papermaking.

Ca(OH)₂+Na₂CO₃→CaCO₃+2NaOH (6)

Calcium carbonate may further be precipitated by reacting sodium carbonate with calcium chloride according to equation (7):

Na₂CO₃+CaCl₂→CaCO₃+2NaCl (7)

### Precipitation of Gypsum

Calcium sulphate is found in various hydrated and anhydrous forms, of which the calcium sulphate dihydrate, CaSO₄.2H₂O, is commonly called gypsum. This dihydrate is the most stable form of calcium sulphate, and thus, it is used in coating pigments. The spontaneous precipitation of the dihydrate form is a common phenomenon in case of boiler sediments, and the precipitation takes place in oversaturated solutions according to the reaction equation (8).

Ca²⁺+SO₄²⁻+2H₂O→CaSO₄.2H₂O (8)

The dihydrate is also precipitated according to the reaction equation (9) from calcium sulphate hemihydrate, CaSO₄.½H₂O once it is slurried in water. The particle size distribution and particle shape of the precipitating gypsum may be influenced by adjusting the precipitation conditions.

2CaSO₄.½H₂O+3H₂O→2CaSO₄.2H₂O (9)

The dihydrate form is also precipitated once calcium phosphate is reacted with sulphuric acid in an aqueous solution according to the reaction equation (10). Also phosphoric acid is formed in the reaction.

Ca₃(PO₄)₂+3H₂SO₄+6H₂O→3CaSO₄.2H₂O+2H₃PO₄ (10).

As the raw phosphate, Ca₁₀(PO₄)₆F₂, reacts with sulphuric acid in an aqueous solution, the dihydrate form of calcium sulphate, phosphoric acid, and hydrofluoric acid are formed according to the reaction equation (11).

Ca₁₀(PO₄)₆F₂+10H₂SO₄+20H₂O→19CaSO₄.2H₂O+6H₃PO₄+2HF (11)

The dihydrate form of calcium sulphate is also precipitated as calcium hydrogen sulphite reacts with oxygen in an aqueous solution according to the reaction equation (12).

Ca(HSO₃)₂(l)+O₂(g)+2H₂O(l)→CaSO₄.2H₂O(s)+H₂SO₄ (12)

### Precipitation of Calcium Oxalate

Calcium oxalate may be produced by precipitation from oxalic acid in the presence of a compound containing calcium. The compound containing calcium may for instance be calcium carbonate, calcium hydroxide, or calcium chloride. The production of calcium oxalate from calcium carbonate and oxalic acid is presented in reaction equations (13)-(14).

CaCO₃+2HCl→CaCl₂+H₂O+CO₂ (13)

CaCl₂+H₂C₂O₄→CaC₂O₄+2HCl (14)

### Precipitation of Titanium Dioxide

Titanium dioxide may be produced for instance with the known sulphate process, that is, by dissolving dried and ground ilmenite, or titanium slurry using concentrated sulphuric acid, and heating to produce a solid reaction product cake. The reaction product cake is dissolved in water or diluted sulphuric acid, and further, solid impurities are removed from the titanium sulphate solution for instance by filtering. The iron content of the solution may be further reduced by cooling, thus precipitating the iron as an iron sulphate heptahydrate that may be removed by filtering. The solution is concentrated to precipitate the titanium as titanium(IV)oxyhydroxide, followed by filtering, washing, and conversion to the desired crystal size and shape by calcination, if necessary. Cellulose particles may then be coated with the titanium dioxide thus obtained using e.g. adsorption, or spin coating processes.

Titanium dioxide may also be produced with the procedure disclosed in the document U.S. Pat. No. 6,001,326, that is by adding ice cubes made of distilled water, or icy distilled water to an undiluted titanium tetrachloride solution, diluting the aqueous solution of titanyl chloride thus obtained to give the desired concentration, followed by heating resulting in the precipitation of finely divided titanium dioxide.

### Precipitation of Aluminum Hydroxide

Aluminium hydroxide, also known as aluminium trihydrate, may be produced from bauxite by dissolving the aluminum contained therein, followed by separation of the other minerals. The aluminium compounds of the solution are extracted with sodium hydroxide and then insoluble impurities are separated by sedimentation and filtration. The clear sodium aluminate filtrate is cooled, followed by the addition of fine aluminum hydroxide crystals, specifically prepared as seed crystals for this purpose, if necessary, and cellulose particles. The aluminate-contained in the filtrate is precipitated on the seed crystals and on cellulose particles added.

### Precipitation of Barium Sulphate

Barium sulphate may be precipitated from barium compounds soluble in water using compounds containing a sulphate group and also soluble in water. Said barium compound may for instance be barium nitrate, sulphide, hydroxide, or chloride, whereas the compound containing a sulphate group is sodium or magnesium sulphate, or sulphuric acid. The preparation of barium sulphate from barium chloride and sodium sulphate is illustrated by the reaction equation (15).

BaCl₂(aq)+Na₂SO₄(aq)→BaSO₄(s)+2NaCl(aq) (15)

### Precipitation of Zinc Oxide

Zinc oxide may be precipitated by heating zinc nitrate, thus resulting in zinc oxide, nitrogen dioxide, and oxygen. Zinc oxide may also be precipitated by heating zinc carbonate, thus giving zinc oxide, and carbon dioxide. Moreover, zinc oxide may be precipitated with calcium oxide, or with calcium hydroxide from a solution containing zinc ions, or by hydrolysis of zinc acetate with lithium hydroxide, or with tetramethylammonium hydroxide in an alcoholic or alcoholic/aqueous solution.

Coating of cellulose particles may be carried out by adding the substance to be precipitated to an aqueous suspension containing cellulose particles, and further, pH and temperature values are optionally adjusted to suitable ranges. Optionally, the suspension containing cellulose particles is combined with an aqueous solution of the precipitating compound and possibly with an adjuvant salt prior to the addition of the substance to be precipitated. If necessary, the addition of the substance to be precipitated is followed by the addition of the precipitating compound as an aqueous, alcoholic, or alcoholic/aqueous solution, or a gaseous form, and/or an acid or seed crystals of the precipitate substance are added.

For the precipitation of silicates and silica, the precipitating compound is selected from the group consisting of inorganic acids, sulphur dioxide, as well as alkaline earth metals, alkali metals, earth metals, salts of zinc and aluminium, preferably sulphate, sulphite, nitrate, and ammonium sulphate salts. The precipitation is particularly preferably carried out using aluminium sulphate, aluminium sulphite, or alkali metal aluminate in the presence of sulphur dioxide, sulphurous acid, or sulphuric acid. Alternatively, the precipitation may also be accomplished with zinc chloride, which will be replaced by a sulphuric acid solution in the final stage of the reaction.

For calcium carbonate precipitation, the precipitating compound may for instance be gaseous carbon dioxide, or sodium carbonate.

In case gypsum is precipitated from calcium phosphate or from raw phosphate, the precipitating compound will be sulphuric acid. In case gypsum is precipitated from calcium hydrogen sulphite in an aqueous solution, gaseous oxygen is used as the precipitating compound. In case the precipitation is carried out in an oversaturated solution, any compound releasing sulphate ions when dissolving in water may be used as the precipitating compound. Alternatively in cases where calcium sulphate dihydrate is precipitated from an aqueous slurry of a hemihydrate, no precipitating compound is needed.

For precipitating calcium oxalate, the precipitating compound is oxalic acid.

For the precipitation of titanium dioxide, the substance to be precipitated may be heated instead of adding a precipitating compound, thus giving finely divided titanium dioxide.

In cases aluminium hydroxide is precipitated, aluminum hydroxide seed crystals are added instead of the precipitating compound, if necessary.

For barium sulphate precipitation, the precipitating compound is a compound containing a sulphate group, such as sodium, or magnesium sulphate, or sulphuric acid.

For zinc oxide precipitation, the precipitating compound is for instance a calcium oxide, hydroxide, lithium hydroxide, or tetramethylammonium hydroxide. In cases zinc nitrate, or zinc carbonate is used as the substance to be precipitated, the addition of a precipitating compound may not be necessary.

For the precipitation of silicates and silicas, the salt serving as an adjuvant is selected from a group consisting of alkaline earth metal salts, and hydroxides. Suitable salts include the chlorides, sulphates, and carbonates of alkaline earth metals such as magnesium, or calcium. Magnesium hydroxide is preferably used.

For the precipitation of silicates, the substance to be precipitated is selected from the group consisting of precipitated silicas, alkali metal and alkaline earth metal silicates, alkali metal and alkaline earth metal aluminiumsilicates, and modifications thereof including mixed salts with alkaline earth metal salts and hydroxides, and further, the mixed salts and combinations of said compounds.

For the precipitation of silicates, the substance to be precipitated is selected from the group consisting of alkali metal, and alkaline earth metal silicates.

For the precipitation of calcium carbonate, the substance to be precipitated is for instance calcium hydroxide, or calcium chloride. Calcium hydroxide is obtained by mixing burnt lime in water, said lime thus reacting to give calcium hydroxide.

For the precipitation of gypsum, the substance to be precipitated is calcium phosphate, calciumsulphate hemihydrate, raw phosphate, calcium hydrogen sulphite, or any compound releasing calcium ions when dissolved in water.

For the precipitation of calcium oxalate, the substance to be precipitated is any compound containing calcium, for instance calcium chloride, calcium carbonate, or calcium hydroxide.

For the precipitation of titanium oxide, the substance to be precipitated is for instance titanyl chloride.

For the precipitation of aluminium hydroxide, the substance to be precipitated is sodium aluminate.

For the precipitation of barium sulphate, the substance to be precipitated is a barium compound, e.g. barium nitrate, sulphide, hydroxide, or chloride.

For the precipitation of zinc oxide, the substance to be precipitated may for instance be zinc nitrate, zinc carbonate, or zinc acetate.

In a preferable embodiment of the coating method of cellulose particles according to the invention, cellulose particles precipitated by spraying dissolved cellulose in dilute sulphuric acid solution are contacted with a light scattering material by the dropwise addition of sodium silicate directly into a regenerating solution containing cellulose particles at the temperature of 20° C. while mixing, thus precipitating silica on said cellulose particles.

In the method for coating cellulose particles of the invention, said cellulose particles may also be coated by adsorbing the light scattering material on said cellulose particles.

In the method for coating cellulose particles of the invention, the cellulose particles may further be coated with the light scattering material using a gas phase coating method, or modified gas phase coating, for instance atomic layer epitaxy.

In the gas phase coating, the coating is formed with chemical reactions by contacting the material to be coated with gaseous starting materials, by allowing for the dissociation and/or chemical reaction of the starting materials in gas phase, followed by the formation of a solid coating on said material to be coated. The reaction may for instance comprise pyrolysis, reduction, oxidation, hydrolysis, or synthesis. Halides, hydrides, metal carbonyls, organometallic compounds, and the like may be used as precursors. For the coating with the gas phase coating technique, the light scattering material is preferably zinc oxide, silicon oxide, or titanium dioxide, the production of which by the as phase coating technique is illustrated by the reaction equation (16):

TiCl₄+2O₂→TiO₂+2Cl₂ (16)

Moreover, in the method of the invention for coating cellulose particles, said cellulose particles may be coated with a light scattering material by forming aqueous layers of the cellulose particles and the light scattering material using spin coating process, or the like. The layers may be deposited in any order, and the number thereof is not limited. Once the layers are solidified, they may be crushed to the desired grain size according to the desired application.

Coated cellulose particles of the invention comprise cellulose particles coated with a light scattering material. The material coating said cellulose particles is selected among light scattering materials. Suitable light scattering materials include silica, silicate, precipitated calcium carbonate (PCC), gypsum, calcium oxalate, titanium dioxide, aluminium hydroxide, barium sulphate, zinc oxide and the like, moreover, the modifications and combinations thereof.

The silicate used for coated cellulose particles is selected from the group consisting of metal silicates such as alkaline earth and alkali metal silicates, alkaline earth and alkali metal aluminium silicates, and modifications thereof such as mixed salts with salts and hydroxides of alkaline earth metals, and mixed salts and combinations of said compounds. The silicate is preferably a calcium silicate, magnesium silicate, sodium aluminum silicate, sodium magnesium silicate, sodium silicate or aluminium silicate, particularly preferably sodium aluminium silicate.

According to the invention, different combinations of coating materials may also be used.

Coated cellulose particles of the invention contain the coating material in an amount ranging from 5 to 95%, preferably from 5 to 20%, or from 50 to 80% by weight of the coated cellulose particles. The proportion of the coating material particularly preferably varies between 5 and 20% by weight of the coated cellulose particles in cases where the disposal of the products comprising said composite is desirably achieved by burning. Ash formation is thus minimized.

The size of the coated cellulose particles ranges between 0.05 and 10 μm, preferably between 0.2 and 2.0 μm. Coating thickness is between 1 nm and 5 μm.

Coated cellulose particles of the invention may be used as fillers in paper and board. The particle size of the coated cellulose particles to be used as fillers preferably varies from 1 to 2 μm. Coated cellulose particles of the invention are suitable fillers both for fine papers and for papers containing mechanical pulp, examples including LWC, ULWC, MWC, and SC.

The coated cellulose particles of the invention may also be used as a coating pigment for papers containing mechanical pulp such as for LWC printing papers, and further, as a coating pigment for boards, for instance FBB board. The particle size of the coated cellulose particles to be used as coating pigments preferably varies from 0.2 to 1 μm.

In the process of the invention for making paper or board, the coated cellulose particles are added to the pulp during paper or board production at a suitable point of the system prior to the press section, preferably in the short circulation and particularly preferably at the proximity of the head box, such as at the suction side of the mixing pump, or at the proximity of the feed pump of the head box, in amounts resulting in filler contents in the paper or board, that is the amount of the coated cellulose particles varying between 1 and 50% by weight, followed by producing the paper or board in a conventional manner.

In the process of the invention for coating paper, the coated cellulose particles are applied using the above suspension either as such or as a mixture with known binders used in coating pigments such as with starch or a latex, thickening agents e.g. carboxymethyl cellulose, or other additives, in amounts resulting in contents of the coated cellulose particles in the coating paste typically varying from 80 to 95% by weight. Application on a paper or board web may be accomplished with any known coating process.

The coated cellulose particles of the invention have several advantages in comparison to fillers and coating pigments of the prior art. Critical properties, particularly the strength properties e.g. the bonding strength and tensile strength index of paper and board may be favourably influenced by the coated cellulose particles without significant adverse effects on the optical properties. In addition, the grammages of paper and board may be lowered and wear of the machines reduced by using said coated cellulose particles.

By means of the methods for producing, and for coating paper and board utilizing the coated cellulose particles of the invention, the proportions of renewable organic materials in papers and boards may be increased, and thus the utilization of papers and boards removed from the recycling system by burning may be improved. Within the European Union, the disposal of compostable materials to landfills will be prohibited in the future, and thus burning will be one of the important alternatives for waste disposal.

### EXAMPLES

### Example 1

### Preparation of Cellulose Particles

A dilution of 5%, by weight, was prepared from cellulose dissolved by the viscose method, said dilution corresponding to a cellulose content of about 0.45%, by weight. 900 g of this dilution was sprayed into 1 litre of 1M sulphuric acid, the cellulose thus precipitating to yield small particles. Said cellulose particles were allowed to sediment and left in the sulphuric acid solution for subsequent coating with silica.

### Example 2

### Coating of Cellulose Particles with Silica

The cellulose particles prepared in Example 1 were coated by the dropwise addition of sodium silicate to 334.4 g of a slurry containing cellulose particles (concentration 0.43%, by weight) at 20° C. while mixing. The added sodium silicate amount totals 1.68 ml (1.095 g). Silica was precipitated on cellulose particles, thus yielding coated cellulose particles containing up to 35% by weight of silica. The cellulose particles thus coated, useful as fillers in paper and board production, are shown in FIG. 1.

### Example 3

### Coating of Cellulose Particles with Silicate

The cellulose particles were prepared as described in Example 1, the majority of the sulphuric acid being filtered off. 36.6 g of aluminium sulphate solution with a concentration of 15%, by weight, and 60.3 g of sodium silicate with a concentration of 21.2%, by weight, were simultaneously added during 1.5 minutes to 1166.5 g of a slurry containing cellulose particles (the concentration being 0.2% by weight), having a temperature of 20.3° C. and a pH of 1.77, while mixing the slurry. The silicate content of the composite thus obtained was determined to be about 4% by weight. The cellulose particles thus coated, useful as fillers and coating pigments in paper and board production, are shown in FIG. 2.

### Example 4

### Coating of Cellulose Particles with Silicate

The cellulose particles were prepared as described in Example 1, the majority of the sulphuric acid being filtered off. 89.2 g of aluminium sulphate solution with a concentration of 20%, by weight, and 180.9 g of sodium silicate with a concentration of 22.2%, by weight, were simultaneously added during 2 minutes to 1170 g of a slurry containing cellulose particles (the concentration being 0.2% by weight), having a temperature of 20.5° C. and a pH of 3.3, while mixing the slurry. Finally, aluminium sulphate was still added to adjust the final pH to a value of 7.5. The silicate content of the composite thus obtained was determined to be about 70% by weight. The cellulose particles thus coated, useful as fillers and coating pigments in paper and board production, are shown in FIGS. 3a and 3b.

### Example 5

### Use of Cellulose Particles Coated with Silica as a Filler in Paper

Sheets were made of pulp consisting of 70% of bleached birch pulp and 30% of bleached softwood pulp, the sheets containing cellulose particles coated with silica of the invention, prepared according to Example 3, as a filler. Sheets without any filler and sheets containing uncoated cellulose particles as the filler served as controls, respectively. Sheets having grammages of 60 g/m² were made according to the standard SCAN-C 26:76. The filler contents were about 6%, and 14%, by weight. The light scattering coefficients, bonding strengths as Scott Bond values, and tensile indices for the sheets were determined with methods according to SCAN-P 8:93, TAPPI T 569, and SCAN-P 67:93.

For sheets containing coated cellulose particles as fillers, light scattering coefficients were similar as for sheets serving as controls, bonding strengths being, however, considerably higher, that is 1.5 times higher than for sheets containing uncoated cellulose particles as the filler, and more than 2 times higher than for sheets without fillers.

### Example 6

### Use of Cellulose Particles Coated with Silicate as a Filler in Paper

Sheets were made of pulp consisting of 70% of bleached birch pulp and 30% of bleached softwood pulp, the sheets containing cellulose particles coated with silicate of the invention, prepared according to Example 4, as a filler. Sheets containing uncoated cellulose particles as the filler and sheets without any filler served as controls. Sheets having grammages of 60 g/m² were made according to the standard SCAN-C 26:76. The filler contents were about 6%, and 14%, by weight. ISO brightnesses and light scattering coefficients of the sheets were determined with methods according to SCAN-P 3:93, and SCAN-P 8:93.

ISO brightnesses and the light scattering coefficients of the sheets are graphically shown in FIGS. 4a and 4b, respectively. As may be seen from FIGS. 4a and 4b, clearly better optical properties are obtained with the coated cellulose particles of the invention than with uncoated cellulose particles.

1-14. (canceled)

15. Method for coating cellulose particles, characterized in that cellulose particles produced by regenerating dissolved cellulose are coated with a light scattering material selected from the group consisting of silica, silicate, PCC, gypsum, calcium oxalate, titanium dioxide, aluminium hydroxide, barium sulphate, zinc oxide, modifications or combinations thereof by precipitating said light scattering material on said cellulose particles.

16. Method of claim 15, characterized in that the size of said cellulose particles ranges from 0.05 to 10 pm.

17. Method according to claim 15, characterized in that said light scattering material is silica.

18. Coated cellulose particles, characterized in that said particles comprise cellulose particles produced by regenerating dissolved cellulose coated with a light scattering material selected from the group consisting of silica, silicate, PCC, gypsum, calcium oxalate, titanium dioxide, aluminium hydroxide, barium sulphate, zinc oxide, modifications or combinations thereof.

19. Coated cellulose particles according to claim 18, characterized in that said particles contain from 5 to 95%, preferably from 5 to 20%, or from 50 to 80%, by weight of the light scattering material.

20. Coated cellulose particles according claim 18, characterized in that the size of the coated cellulose particles ranges from 0.05 to 10 μm, preferably from 0.2 to 2.0 μm.

21. Use of the coated cellulose particles according to claim 18 as a filler of paper or board.

23. Use of the coated cellulose particles according to claim 18 as a coating pigment of paper and board.

24. Method for producing paper or board, characterized in that coated cellulose particles according to claim 18 are added to pulp, followed by producing of the paper in a conventional manner.

25. Method for coating paper or board, characterized in that coated cellulose particles according to claim 18 are applied as a suspension or as an admixture with the coating adjuvants on a paper or board web using known methods.

26. Method according to claim 16, characterized in that said light scattering material is silica.

27. Coated cellulose particles according claim 19, characterized in that the size of the coated cellulose particles ranges from 0.05 to 10 μm, preferably from 0.2 to 2.0 μm.

28. Use of the coated cellulose particles according to claim 19 as a filler of paper or board.

29. Use of the coated cellulose particles according to claim 20 as a filler of paper or board.

30. Use of the coated cellulose particles according to claim 19 as a coating pigment of paper and board.

31. Use of the coated cellulose particles according to claim 20 as a coating pigment of paper and board.

32. Method for producing paper or board, characterized in that coated cellulose particles according to claim 19 are added to pulp, followed by producing of the paper in a conventional manner.

33. Method for producing paper or board, characterized in that coated cellulose particles according to claim 20 are added to pulp, followed by producing of the paper in a conventional manner.

34. Method for coating paper or board, characterized in that coated cellulose particles according to claim 19 are applied as a suspension or as an admixture with the coating adjuvants on a paper or board web using known methods.
